(19) United States
(12) Patent Application Publication
(10) Pub. No.: US 2025/0294606 A1
(43) Pub. Date: Sep. 18, 2025

(54) QUEUE MANAGEMENT FOR PACKET TRANSMISSION IN SATELLITE COMMUNICATION SYSTEM

(71) Applicant: Kratos Integral Holdings LLC, San Diego, CA (US)

(72) Inventor: Markus Eslitzbichler, Drammen (NO)

(73) Assignee: Kratos Integral Holdings LLC, San Diego, CA (US)

(21) Appl. No.: 18/603,929

(22) Filed: Mar. 13, 2024

(51) Int. Cl. H04W 72/543; H04L 1/00; H04W 84/06

(52) U.S. Cl. CPC H04W 72/543; H04L 1/0003; H04L 1/0009; H04W 84/06

(57) ABSTRACT

Described herein are systems, methods, and other techniques for managing queues for transmission of PDUs in a satellite communication system. The PDUs are received at a gateway having a first set of queues corresponding to different CoSs and a second set of queues corresponding to different Modcod schemes. The PDUs are loaded into the first set of queues in accordance with a set of CoS assignments. An available bandwidth in the second set of queues is allocated amongst the first set of queues. The PDUs are released from the first set of queues in accordance with the allocated available bandwidth. The PDUs are loaded into the second set of queues in accordance with a set of Modcod scheme assignments for the PDUs. The PDUs are released from the second set of queues for transmission in the satellite communication system.

### BACKGROUND OF THE INVENTION

Satellite communication systems play a crucial role in facilitating global connectivity across diverse applications, including telecommunications, broadcasting, internet services, and remote sensing. These systems operate by transmitting signals between ground-based Earth stations and satellites in orbit. The efficiency and reliability of such systems are important to addressing the increasing demands of contemporary communication and data services. Presently, communications engineers encounter numerous challenges, with a key concern being the optimization of information transmission over limited resources. Given the scarcity of available frequencies for radio signal communication and the rapid growth in the volume of information to be conveyed, there is a need to maximize the efficiency of available frequencies through the use of new hardware and software solutions at the ground stations, terminals, and satellites that make up such communication systems.

### SUMMARY OF THE INVENTION

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is a method of managing queues for transmission of protocol data units (PDUs) in a satellite communication system, the method comprising: receiving the PDUs at a gateway, the gateway having a first set of queues each corresponding to a different class of service (CoS) and a second set of queues each corresponding to a different modulation and coding (Modcod) scheme; loading the PDUs into the first set of queues in accordance with a set of CoS assignments for the PDUs; allocating an available bandwidth in the second set of queues amongst the first set of queues; releasing the PDUs from the first set of queues in accordance with the allocated available bandwidth; loading the PDUs into the second set of queues in accordance with a set of Modcod scheme assignments for the PDUs; and releasing the PDUs from the second set of queues for transmission in the satellite communication system.

Example 2 is the method of example(s) 1, wherein allocating the available bandwidth in the second set of queues amongst the first set of queues includes counting a number of guaranteed PDUs that are stored in each of the first set of queues, wherein the available bandwidth in the second set of queues is allocated proportionally amongst the first set of queues based on the number of guaranteed PDUs and their respective sizes in each of the first set of queues.

Example 3 is the method of example(s) 1, further comprising: assigning a CoS to each of the PDUs to generate the set of CoS assignments for the PDUs.

Example 4 is the method of example(s) 1, further comprising: determining applicable service level guarantees for each of the PDUs.

Example 5 is the method of example(s) 1, further comprising: determining the available bandwidth in the second set of queues based on a number of the PDUs and their respective sizes that are stored in each of the second set of queues.

Example 6 is the method of example(s) 1, further comprising: assigning a Modcod scheme to each of the PDUs to generate the set of Modcod scheme assignments for the PDUs, wherein each of the set of Modcod scheme assignments includes one or both of a modulation scheme assignment or a coding rate assignment.

Example 7 is the method of example(s) 6, wherein the set of Modcod scheme assignments are generated based on an estimated signal-to-noise ratio of a communication channel between the gateway and one or more terminals.

Example 8 is the method of example(s) 1, further comprising: after releasing the PDUs from the second set of queues, encapsulating the PDUs to produce baseband frames.

Example 9 is the method of example(s) 8, further comprising: modulating the baseband frames to produce digital waveforms; digitizing the digital waveforms to produce analog signals; and transmitting the analog signals to one or more terminals via a satellite.

Example 10 is a non-transitory computer-readable medium comprising instructions that, when executed by one or more processors, cause the one or more processors to perform operations for managing queues for transmission of protocol data units (PDUs) in a satellite communication system, the operations comprising: receiving the PDUs at a gateway, the gateway having a first set of queues each corresponding to a different class of service (CoS) and a second set of queues each corresponding to a different modulation and coding (Modcod) scheme; loading the PDUs into the first set of queues in accordance with a set of CoS assignments for the PDUs; allocating an available bandwidth in the second set of queues amongst the first set of queues; releasing the PDUs from the first set of queues in accordance with the allocated available bandwidth; loading the PDUs into the second set of queues in accordance with a set of Modcod scheme assignments for the PDUs; and releasing the PDUs from the second set of queues for transmission in the satellite communication system.

Example 11 is the non-transitory computer-readable medium of example(s) 10, wherein allocating the available bandwidth in the second set of queues amongst the first set of queues includes counting a number of guaranteed PDUs that are stored in each of the first set of queues, wherein the available bandwidth in the second set of queues is allocated proportionally amongst the first set of queues based on the number of guaranteed PDUs and their respective sizes in each of the first set of queues.

Example 12 is the non-transitory computer-readable medium of example(s) 10, wherein the operations further comprise: assigning a CoS to each of the PDUs to generate the set of CoS assignments for the PDUs.

Example 13 is the non-transitory computer-readable medium of example(s) 10, further comprising: determining applicable service level guarantees for each of the PDUs.

Example 14 is the non-transitory computer-readable medium of example(s) 10, wherein the operations further comprise: determining the available bandwidth in the second set of queues based on a number of the PDUs and their respective sizes that are stored in each of the second set of queues.

Example 15 is the non-transitory computer-readable medium of example(s) 10, wherein the operations further comprise: assigning a Modcod scheme to each of the PDUs to generate the set of Modcod scheme assignments for the PDUs, wherein each of the set of Modcod scheme assignments includes one or both of a modulation scheme assignment or a coding rate assignment.

Example 16 is the non-transitory computer-readable medium of example(s) 15, wherein the set of Modcod scheme assignments are generated based on an estimated signal-to-noise ratio of a communication channel between the gateway and one or more terminals.

Example 17 is the non-transitory computer-readable medium of example(s) 10, wherein the operations further comprise: after releasing the PDUs from the second set of queues, encapsulating the PDUs to produce baseband frames.

Example 18 is the non-transitory computer-readable medium of example(s) 17, wherein the operations further comprise: modulating the baseband frames to produce digital waveforms; digitizing the digital waveforms to produce analog signals; and transmitting the analog signals to one or more terminals via a satellite.

Example 19 is a system comprising: one or more processors; and a non-transitory computer-readable medium comprising instructions that, when executed by the one or more processors, cause the one or more processors to perform operations for managing queues for transmission of protocol data units (PDUs) in a satellite communication system, the operations comprising: receiving the PDUs at a gateway, the gateway having a first set of queues each corresponding to a different class of service (CoS) and a second set of queues each corresponding to a different modulation and coding (Modcod) scheme; loading the PDUs into the first set of queues in accordance with a set of CoS assignments for the PDUs; allocating an available bandwidth in the second set of queues amongst the first set of queues; releasing the PDUs from the first set of queues in accordance with the allocated available bandwidth; loading the PDUs into the second set of queues in accordance with a set of Modcod scheme assignments for the PDUs; and releasing the PDUs from the second set of queues for transmission in the satellite communication system.

Example 20 is the system of example(s) 19, wherein allocating the available bandwidth in the second set of queues amongst the first set of queues includes counting a number of guaranteed PDUs that are stored in each of the first set of queues, wherein the available bandwidth in the second set of queues is allocated proportionally amongst the first set of queues based on the number of guaranteed PDUs and their respective sizes in each of the first set of queues.

Example 21 is the system of example(s) 19, wherein the operations further comprise: assigning a CoS to each of the PDUs to generate the set of CoS assignments for the PDUs.

Example 22 is the system of example(s) 19, further comprising: determining applicable service level guarantees for each of the PDUs.

Example 23 is the system of example(s) 19, wherein the operations further comprise: determining the available bandwidth in the second set of queues based on a number of the PDUs and their respective sizes that are stored in each of the second set of queues.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example communication path between end points enabled by a satellite communication system.

FIG. 2 illustrates an example satellite communication system including a gateway and a set of terminals.

FIG. 3 illustrates an example digital IF packet with multiple protocol layers.

FIGS. 4A-4C illustrate example traffic adapters implementing different network types.

FIG. 5 illustrates an example functionality of a traffic adapter to provide carrier Ethernet services over satellite.

FIGS. 6A-6E illustrate example steps for managing queues for transmission of PDUs in a satellite communication system.

FIG. 7 illustrates a method of managing queues for transmission of PDUs in a satellite communication system.

FIG. 8 illustrates an example computer system comprising various hardware elements.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

Embodiments of the present disclosure relate to a technique for managing queues at a gateway that enables transmission of protocol data units (such as Ethernet frames or internet protocol (IP) packets) within a satellite communication environment. Embodiments implement a mechanism for providing carrier Ethernet services over satellite in both point-to-point and point-to-multipoint applications. In some embodiments, a traffic adapter running at the gateway implements a quality of service (QOS) system and an Adaptive Coding and Modulation (ACM) system, each having a respective set of queues to temporarily store PDUs while in transit. A bandwidth controller performs a feedback function that forces the release of PDUs from the QoS system queues (or “class of service (CoS) queues”) to be dependent on the available bandwidth in the ACM system queues (or “modulation and coding (Modcod) queues”), putting the decision to drop any PDUs exclusively on the QoS system while preventing the ACM system from doing so.

PDUs input into the traffic adapter may be assigned a service identifier and a class of service. The packets may then be stored in the corresponding CoS queues based on the assigned identifiers and assigned class of service. In some examples, data packet traffic from one or more interfaces is grouped into services based on interface and virtual local area network (VLAN) identifier (ID). Traffic within each of these services may further be divided into one or more classes of service, where each class of service has certain performance requirements (latency, jitter, loss rates, etc.).

The ACM system maintains the Modcod queues, with one queue per Modcod scheme. PDUs coming out of the QoS system may be placed in those queues based on the signal-to-noise ratio of the intended receivers within current channel conditions. In some examples, the ACM system continuously monitors the amount of data collected in the Modcod queues and estimates the overall transmission latency. The bandwidth controller may compare this overall transmission latency to a configurable threshold value, and may use the difference between the two to control the release of packets from the CoS queues into the Modcod queues. The bandwidth controller is aware of both the satcom concept of “ACM” and the terrestrial Carrier Ethernet QoS expectations. In some examples, the bandwidth performs a multi-level bandwidth distribution algorithm, which determines bandwidth to be allocated to services on a symbol-level, and then converts this to a bitrate assignment for individual services.

As noted above, the system may be configured such that packets inside the Modcod queues are never dropped. If packets need to be delayed or dropped due to congestion, the QoS system has the responsibility to make intelligent decisions about what to prioritize and what to deprioritize. Some benefits of the present disclosure are achieved by keeping Modcod queues small and using the feedback loop to inform the QoS system how many data packets can be released from the CoS queues into the ACM system.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

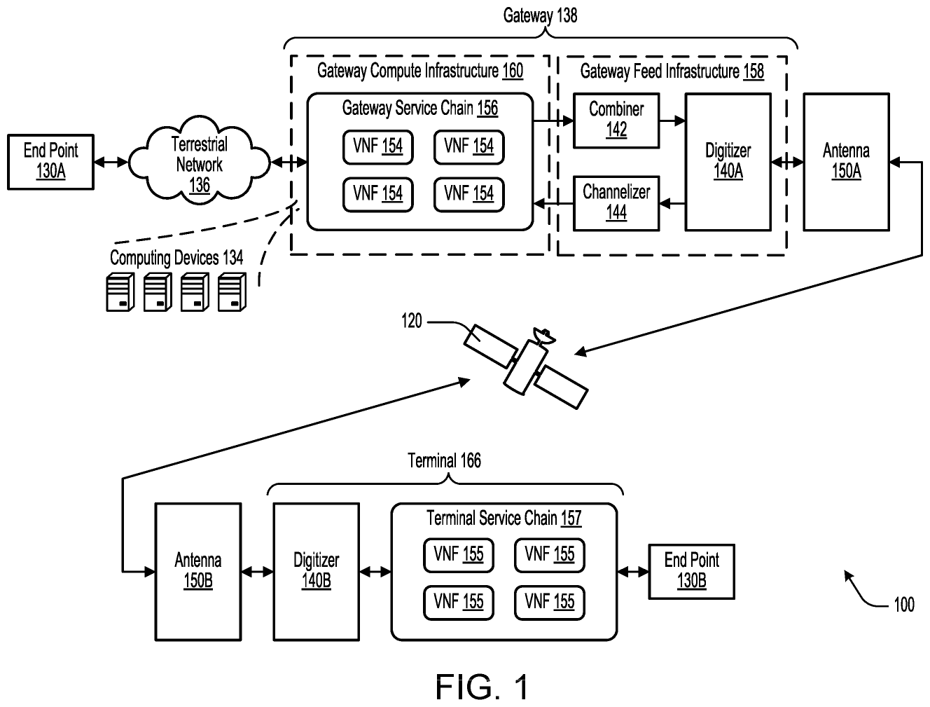

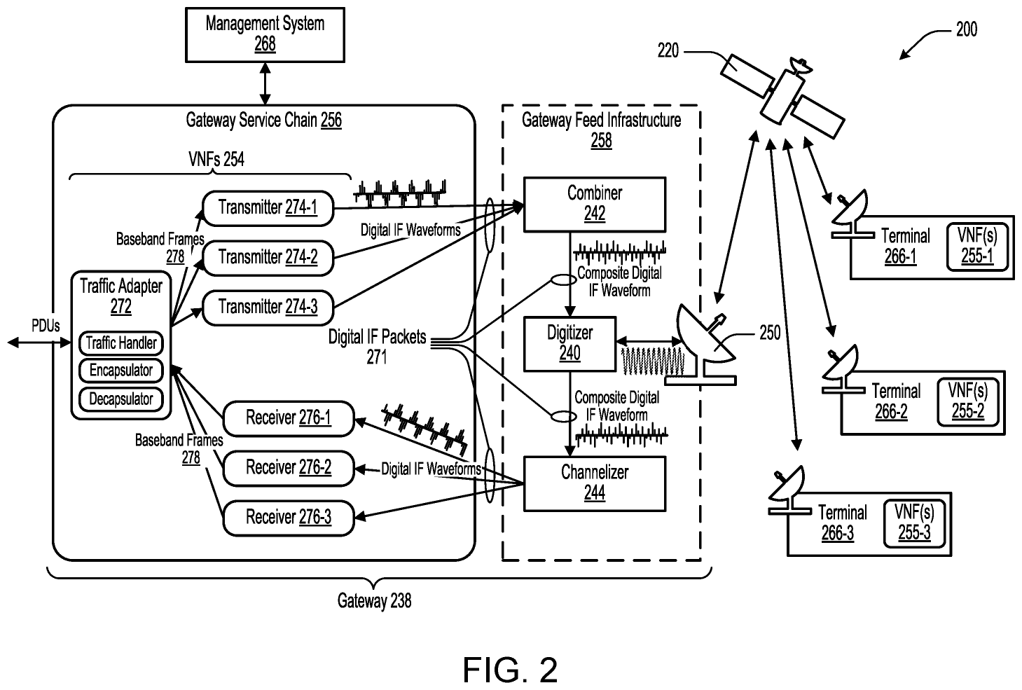

The figures herein follow a numbering convention in which the first digit or digits correspond to the figure number and the remaining digits identify an element or component in the figure. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates an example communication path between an end point 130A and an end point 130B enabled by a satellite communication system 100, in accordance with some embodiments of the present disclosure. In the illustrated example, satellite communication system 100 includes a gateway 138 in communication with a terminal 166 via a satellite 120. In various examples, satellite 120 may send and receive wireless signals within one or more bands of a number of possible frequency bands between 1-300 GHz including, for example, 1 GHZ and 300 GHz, including L Band (1-2 GHZ), C-Band (4-8 GHZ), X-Band (8-12 GHz), Ku-Band (12-18 GHZ), Ka-Band (26.5-40 GHZ), S-Band (2-4 GHZ), and V-Band (40-75 GHZ).

In various examples, end points 130 may correspond to portable mobile devices, internet of things (IoT) devices, desktop computers, user terminals, or any of a number of devices with communication capabilities. Alternatively, end points 130 may correspond to networks such as mobile towers, mining sites, ships, planes, or the like. In one example, end point 130A may correspond to a service and end point 130B may correspond to a consumer. It should be understood that the satellite communication environment may comprise other end points 110 and/or other arrangements of components than those illustrated. Furthermore, multiple communication paths may be constructed and operated in parallel, and separate communication paths may have different arrangements from each other.

End point 130A may be communicatively connected via a terrestrial network 136 (e.g., comprising the Internet, a private telecom backbone, or a cloud compute center) to a gateway 138. Gateway 138 may include one or more switches (not shown) to facilitate communication between the various components, such as a first switch at the boundary between terrestrial network 136 and a gateway compute infrastructure 160, and a second switch at the boundary between gateway compute infrastructure 160 and a gateway feed infrastructure 158. Such switches may be physical or virtual Gigabit Ethernet (GigE) switches. However, it should be understood that the above-described first and second switches could be implemented in the same switch. In some examples, the first switch may implement transport from terrestrial network 136 to a VNF 154 within a gateway service chain 156. In such a case, VNF 154 may act as a User Network Interface (UNI) or an External Network-Network Interface (ENNI) as defined by the applicable MEF Ethernet services and MEF operator services standards. Alternatively, the first switch may itself represent the UNI or ENNI as defined by the applicable MEF standards.

Gateway compute infrastructure 160 may include a set of computing devices 134 situated onsite (at a same physical location) or offsite (at a different physical location) relative to antenna 150. In some examples, computing devices 134 may comprise general-purpose computers or servers capable of running VNFs 154 and other virtualization software such as hypervisors to support gateway service chain 156. In some examples, computing devices 134 may employ x86 architectures, ARM architectures, RISC-V architectures, among other possibilities. Computing devices 134 may be configured as clusters, data centers, warehouse-scale computers, among other possibilities. Gateway compute infrastructure 160 may further include suitable storage systems that provide persistent and reliable storage in support of VNFs 154.

In some examples, gateway compute infrastructure 160 may include a managing system that instantiates and configures one or more VNFs 154 to form gateway service chain 156. Two sets of one or more VNFs 154 may provide two-way communication, including a transmission path and a reception path, between terrestrial network 136 and a gateway feed infrastructure 158 of gateway 156. It should be understood that in an example in which gateway service chain 156 provides only one-way communication, VNFs 154 may provide only a transmission path without providing a reception path. The set of VNFs 154 (e.g., implementing a gateway) on the forward path towards the link to satellite 120, may comprise or constitute a traffic handler, an encapsulator (e.g., implementing generic stream encapsulation (GSE)), a modulator (e.g., the OpenSpace™ Wideband Software modulator, offered by Kratos Defense & Security Solutions, Inc. of San Diego, California), a combiner, an encryption/decryption VNF, a time division multiple access (TDMA) resource allocator, an antenna controller, among other possibilities.

This set of VNFs 154 on the transmission path may convert protocol data units (PDUs) into a digital signal (such as a digital intermediate frequency (IF) waveform or a composite digital IF waveform). For example, the traffic handler may process data link layer (e.g., Layer 2 or L2 in the Open Systems Interconnection (OSI) model) and/or network layer (e.g., Layer 3 or L3 in the OSI model) traffic, and provide the processed Ethernet frames or IP packets to the encapsulator. The encapsulator may convert the PDUs into baseband frames, and provide the baseband frames to the modulator. A baseband frame may be the basic unit of transmission in satellite communication system 100. The encapsulator may form baseband frames in accordance with the 5G standard, the DVB-S2x standard, described in European Telecommunications Standards Institute (ETSI) European Standard (EN) 302 307-1 v1.4.1 (2014-11), among other possible standards. The encapsulator may comprise one or more VNFs 154 (or software subprocesses) that perform one or more of the following functions: frame chopping, forward modulation selection (e.g., with Adaptive Coding and Modulation (ACM)), Ethernet bridge (e.g., Media Access Control (MAC) table, smart bridging/learning/relay, etc.), Address Resolution Protocol (ARP) (e.g., Ethernet MAC discovery), VLAN manipulation (e.g., to rewrite Ethernet frames on ingress/egress based on the MEF service definition), header compression (e.g., Robust Header Compression (ROHC)); and/or OTA optimization (e.g., Space Communications Protocol Specifications (SCPS)/TCP-Acceleration). The modulator may convert the baseband frames into signal data packets in accordance with a particular standard, including the standards of the Digital Intermediate Frequency Interoperability (DIFI) Consortium in the DIFI/Institute of Electrical and Electronics Engineers (IEEE) 1.0 specification, the VMEbus International Trade Association (VITA) standard, the enhanced Common Public Radio Interface (eCPRI) standard, among other possibilities. In an embodiment, the encapsulator and the traffic handler may be implemented as a single VNF 154, referred to as a virtualized traffic adaptor (vModem). The VNF-implemented combiner or a combiner 142 (implemented in hardware) may combine the signal data packets into a digital signal and provide the digital signal to a digitizer 140A, which may convert the digital signal into an analog signal.

The set of VNFs 154 on the return path may comprise or constitute, in order, a digital channelizer (e.g., the OpenSpace™ Wideband Channelizer, offered by Kratos Defense & Security Solutions, Inc. of San Diego, California), a demodulator (e.g., the OpenSpace™ Wideband Software Receiver, offered by Kratos Defense & Security Solutions, Inc. of San Diego, California), and a decapsulator. This set of VNFs 154 on the reception path may convert a digital signal (such as a digital IF waveform or a composite digital IF waveform) to PDUs, which may be Ethernet frames or IP packets, among other possibilities. For example, the VNF-implemented channelizer or a channelizer 144 (implemented in hardware) may receive a digital signal from digitizer 140A, which has converted an analog signal into the digital signal, and divide the digital signal into signal data packets. The demodulator may convert the signal data packets to baseband frames, and provide the baseband frames to the decapsulator. The decapsulator may convert the baseband frames into PDUs, which may be transmitted, via terrestrial network 136, to end point 130A. It should be understood that the demodulator performs the reverse function(s) of the modulator, and the decapsulator performs the reverse function(s) of the encapsulator. In an embodiment, the decapsulator and demodulator may be implemented as a single VNF 154, for example, together with the traffic handler, encapsulator, and modulator, in a vModem. In other words, a vModem may consist of a single VNF 154 that implements all of the functions of the traffic handler, encapsulator/decapsulator, and modulator/demodulator.

In some embodiments, in which gateway service chain 156 implements a vModem, the vModem may comprise one or more modulators that are configured to modulate waveforms according to a digital satellite broadcast standard and/or one or more demodulators that are configured to demodulate waveforms according to a digital satellite broadcast standard. Such a vModem may provide carrier ethernet (CE) services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames. The digital satellite broadcast standard may be a digital satellite television broadcast standard, such as the DVB-S2X standard managed by the Digital Video Broadcasting (DVB) Project. While a digital satellite broadcast standard, such as a DVB standard, is used as an example, the vModem may be configured to modulate and demodulate waveforms according to other standards for wideband digital communication, such as orthogonal frequency-division multiplexing (OFDM), or the like.

The digital signal from combiner 142 is transmitted to digitizer 140A, which converts the digital signal output by combiner 142 into an analog transmission signal for communication to satellite 120. Digitizer 140A further digitizes analog reception signals from satellite 120 into digital signals for use by channelizer 144. In some examples, digitizer 140A may be software-defined. As one example, digitizer 140A may be a SpectralNet™, which is a carrier-grade RF digitizer, offered by Kratos Defense & Security Solutions, Inc. of San Diego, California. Digitizer 140A communicates with antenna 150A. In particular, digitizer 140A provides the transmission signal to antenna 150A, which transmits the transmission signal to satellite 120. In addition, in two-way communications, antenna 150A receives a reception signal from satellite 120, and provides the reception signal to digitizer 140A.

In various examples, antenna 150A may be a parabolic reflector antenna, a flat panel antenna, a phased array antenna, a helical antenna, a patch antenna, a horn antenna, among other possibilities. In some examples, antenna 150A may be an electronically steered antenna that can use electronic means to control the direction and shape of its radiation pattern. Such an antenna can generate multiple beams simultaneously, allowing it to transmit or receive signals in multiple directions at the same time. Antenna 150A may include both the physical antenna as well as the corresponding radio frequency (RF) subsystem, which may include a combination of diplexers, amplifiers (e.g., low noise amplifiers (LNAs)), upconverters, and downconverters (e.g., low-noise block downconverters (LNBs) depending on the specific frequency band and application.

Satellite 120 relays wireless signals from antenna 150A to antenna 150B. In two-way communications, satellite 120 also relays wireless signals from antenna 150B to antenna 150A. Antenna 150B may be functionally similar or identical to antenna 150A, and therefore, any description of antenna 150A applies equally to antenna 150B, which may not be redundantly described herein. Similarly, digitizer 140B may be functionally similar or identical to digitizer 140A, and therefore, any description of digitizer 140A applies equally to digitizer 140B, which may not be redundantly described herein.

Digitizer 140B may communicate directly with a terminal service chain 157 of a terminal compute infrastructure. Terminal service chain 157 may comprise a set of VNF(s) 155 forming a reception path from digitizer 140B to end point 130B. In two-way communications, terminal service chain 157 may also comprise a set of VNFs 155 forming a transmission path from end point 130B to digitizer 140B. The reception and transmission paths may be identical or similar to the reception and transmission paths described with respect to gateway service chain 156. For example, the reception path may comprise a demodulator followed by a decapsulator to convert signal frames into PDUs, and the transmission path may comprise an encapsulator followed by a modulator to convert PDUs into signal frames. The traffic handler, encapslator, decapsulator, modulator, and demodulator may all be similar or identical to those described with respect to gateway service chain 156, and therefore, the descriptions of those components with respect to gateway service chain 156 apply equally to those components in terminal service chain 157.

Terminal service chain 157 may communicate with end point 130B. For example, the traffic handler of terminal service chain 157 may transmit Ethernet frames to end point 130B. In addition, in two-way communications, the encapsulator of terminal service chain 157 may receive Ethernet packets from end point 130B. Thus, the combination of gateway service chain 156 and terminal service chain 157 enable one-way or two-way communications between end points 110A and 110B over a satellite link.

Gateway service chain 156 and terminal service chain 157 may comprise one or more of the software-defined components (e.g., VNFs and/or digitizers) described in International Patent App. Nos. PCT/US2021/033867, filed on May 24, 2021, PCT/US2021/033875, filed on May 24, 2021, PCT/US2021/033905, filed on May 24, 2021, and PCT/US2021/062689, filed on Dec. 9, 2021, which are all hereby incorporated herein by reference as if set forth in full.

Advantageously, the utilization of VNFs and software-defined components (e.g., digitizers 140A and 140B) to perform various functions, aid in automation and scalability. Embodiments may minimize the presence of physical hardware components, such that satellite communication system 100 can be dynamically reconfigured (e.g., added, updated, destroyed, increased or decreased in dimension, etc.) in real time, primarily using in-band network communications, to adapt to the unique multivariate satcom environment (e.g., changing traffic patterns, RF interference, atmospheric characteristics, antenna conditions, path length, etc.).

Notably, dynamic reconfiguration of VNFs in a cloud computing environment can be used, not only to increase the dimensions of the computing resources (e.g., number of vCPUs, amount of memory and/or disk storage, network throughput, etc.) used for satellite communication system 100 on demand to ensure the sufficiency of the satellite communication system, but also to decrease the dimensions of the computing resources on demand to optimize the utilization of the hardware. For example, favorable changes in the satcom environment may improve performance of satellite communication system 100, such that satellite communication system 100 is providing significantly better performance than is required by the service level agreement. In this case, the management system may determine that gateway service chain 156 and terminal service chain 157 are insufficient, and update the service chains to reduce the resources used in the service chains (e.g., by reducing RF bandwidth usage, resizing one or more VNFs, swapping to a service chain with reduced dimensions, etc.). This is in contrast to conventional hardware-based service chains in which unused resources would simply be idled or otherwise ignored, representing a sunk cost that cannot be recouped.

FIG. 2 illustrates an example satellite communication system 200 including a gateway 238 and a set of terminals 266 (or “remote terminals”), in accordance with some embodiments of the present disclosure. In the illustrated example, satellite communication system 200 includes a gateway 238 (or “hub”) in communication with each of terminals 266 via a satellite 220. Gateway 238 may include a gateway feed infrastructure 258 that serves as an onsite infrastructure (close to antenna 250, e.g., at a same physical location) that may perform primarily signal digitization and signal routing-related tasks and a gateway compute infrastructure that can be onsite or offsite infrastructure (far from antenna 250, e.g., at a different physical location) that supports a gateway service chain 256 that performs primarily signal processing and packet processing-related tasks. The gateway compute infrastructure may include one or more computers, clusters, a data center, or a warehouse-scale computer. The computing devices comprising the gateway compute infrastructure and/or gateway feed infrastructure 258 may include general-purpose computers or servers employing x86 architectures, ARM architectures, RISC-V architectures, among other possibilities.

Gateway 238 may include a gateway service chain 256 comprising a set of VNFs 254 running on the gateway compute infrastructure. Example VNFs include one or more traffic adapters 272, one or more virtual transmitters 274, one or more virtual receivers 276, among other possibilities. Each of VNFs 254 may be instantiated and configured by a management system 268 that scales up or down the number of active VNFs based on the number of active terminals 266. Management system 268 may further configure VNFs 254 such that satellite communication system 200 implements any one of a number of network topologies, including a single channel per carrier (SCPC) network, a TDMA network, a frequency division multiple access (FDMA) network, a mesh network, among other possibilities.

VNFs 254 may include one or more virtual transmitters 274 that provide one or more transmission paths between a terrestrial network and a gateway feed infrastructure 258 of gateway 256. Each of the set of virtual transmitters 274 on a transmission path may comprise or constitute a modulator (e.g., the OpenSpace™ Wideband Software modulator) that converts incoming baseband frames 278 into digital IF packets 271 containing digital waveforms at IF or RF frequencies (or “digital IF waveforms”). Traffic adapter 272 acts as the bridge between the terrestrial network and the satellite network. In some examples, traffic adapter 272 may include a traffic handler that processes data link layer (e.g., Layer 2 in the OSI model) and/or network layer (e.g., Layer 3 in the OSI model) traffic and provides the processed PDUs to the encapsulator, which convert the PDUs into baseband frames 278 and provides baseband frames 278 to one of virtual transmitters 274. Each of virtual transmitters 274 may implement a modulator that converts baseband frames 278 into digital IF packets 271 (e.g., according to the standards of the DIFI Consortium in the DIFI/IEEE 1.2 specification) to create the digital IF waveforms.

Digital IF packets 271 generated by virtual transmitters 274 may be fed into a combiner 242 that combines the multiple digital IF waveforms into a single composite signal (or “composite digital IF waveform”). Digital IF packets 271 containing the composite digital IF waveform is fed into a digitizer 240 that converts the digital signal into an analog signal in preparation for wireless transmission via an antenna 250. While combiner 242 is illustrated in FIG. 2 as being an element of gateway feed infrastructure 258, it is to be understood that a combiner VNF (or multiple combiner VNFs) may be instantiated by management system 268 to perform similar functionality.

On the reception path, digitizer 240 digitizes analog signals received from satellite 220 to generate digital IF packets 271 containing digital IF waveforms (e.g., a composite digital IF waveform) of the received analog signals for use by a channelizer 244. The composite digital IF waveform received by channelizer 244 may be a wide-band spectrum (e.g., 100 MHz, 500 MHZ, 300 GHz, etc.) that may contain several signals within that segment of the frequency band. In some instances, channelizer 244 divides the composite digital IF waveform into separate digital IF waveforms and sends the waveforms (in the form of digital IF packets 271) to appropriate virtual receivers 276. While channelizer 244 is illustrated in FIG. 2 as being an element of gateway feed infrastructure 258, it is to be understood that a channelizer VNF (or multiple channelizer VNFs) may be instantiated by management system 268 to perform similar functionality. VNFs 254 may include one or more virtual receivers 276 that provide one or more reception paths between gateway feed infrastructure 258 and a terrestrial network. Each of the set of virtual receivers 276 on a reception path may comprise or constitute a demodulator (e.g., the OpenSpace™ Wideband Software Receiver) that converts incoming digital IF packets 271 containing digital IF waveforms into baseband frames 278. In some examples, baseband frames 278 produced by virtual receivers are sent to the decapsulator of traffic adapter 272. The decapsulator may convert baseband frames 278 into Ethernet frames and pass the Ethernet frames to the traffic handler, which processes and provides the Ethernet frames to a terrestrial network.

Satellite 220 relays wireless signals from antenna 250 to the antennas of terminals 266, or vice versa. In two-way communications, satellite 220 also relays wireless signals from the antennas of terminals 266 to antenna 250. In some examples, each of terminals 266 may include hardware infrastructure to support one or more VNFs 255. In some examples, VNFs 255 at each of terminals 266 may implement a vModem that comprises one or more modulators that are configured to modulate waveforms according to a digital satellite broadcast standard and/or one or more demodulators that are configured to demodulate waveforms according to the digital satellite broadcast standard. Such a vModem may provide CE services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames, together with a traffic handler that connects the encapsulators and decapsulators with the terrestrial networks connected to terminals 266.

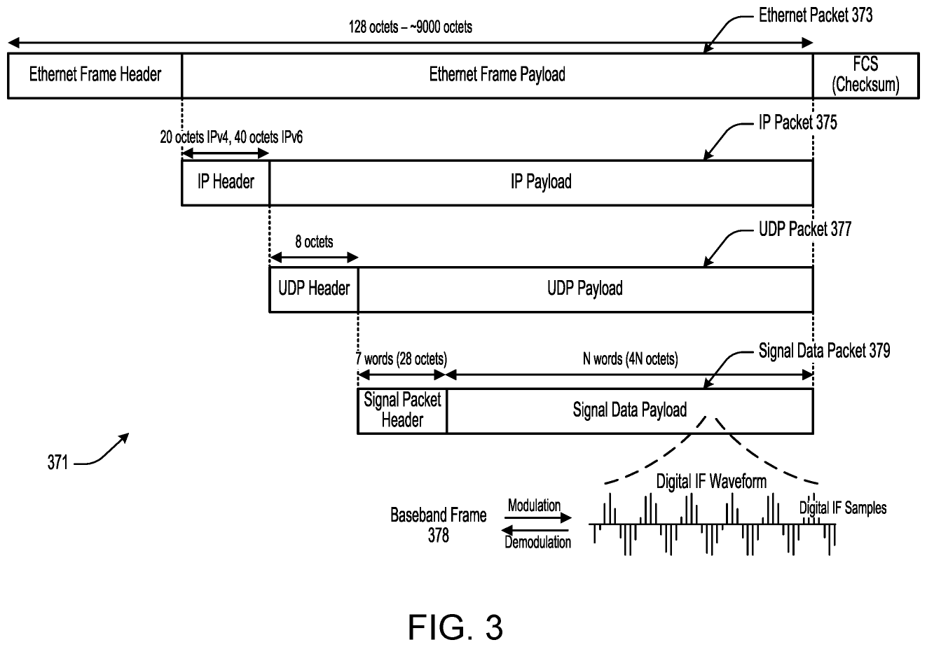

FIG. 3 illustrates an example digital IF packet 371 with multiple protocol layers, in accordance with some embodiments of the present disclosure. In the illustrated example, digital IF packet 371 includes a digital IF waveform contained within the signal data payload of a signal data packet 379. The digital IF waveform may represent the modulated form of one or more baseband frames 378 (or portions of one or more baseband frames 378), such that the baseband frames may be recovered by demodulating the digital IF waveform contained within the signal data payload. Signal data packet 379 may also include a signal packet header, which may implement the VITA standard (e.g., VITA 49.2 specification) or another standard.

In some examples, signal data packet 379 is encapsulated within a UDP packet 377 having a UDP header and UDP payload. UDP packet 377 may be encapsulated within an IP packet 375 having an IP header and IP payload, which may be encapsulated within an Ethernet packet 373 having an Ethernet frame header and Ethernet frame payload. In some examples, the total Ethernet packet size varies based on the number and size of the data samples in the signal data payload of signal data packet 379. There may be a fixed overhead within the Ethernet frame which comprises the IP header (20 octets for IPV4 or 40 octets (minimum) for IPV6), the UDP header (8 octets), the signal packet header (28 octets). In some examples, the Ethernet frame payload is adjustable from 128 octets to approximately 9000 octets.

In some examples, digital IF packet 371 may include different packet classes for signal data packet 379. In a first packet class, signal data packet 379 may be a regular data packet that includes the data for the digital samples forming the digital IF waveform. In a second packet class, signal data packet 379 may be a context packet that includes data to ensure standardization of the transport of metadata describing the sampled signal data. Such data may include the IF reference frequency, the sample rate, the bit depth, the equivalent analog bandwidth of the signal represented by the digital stream, the frequency offset of the center of the band occupied by the signal from the IF reference frequency, among other possibilities. In a third packet class, signal data packet 379 may be a command packet that includes data used to provide and acknowledge device settings and support control of timing to permit synchronization of upstream or downstream devices.

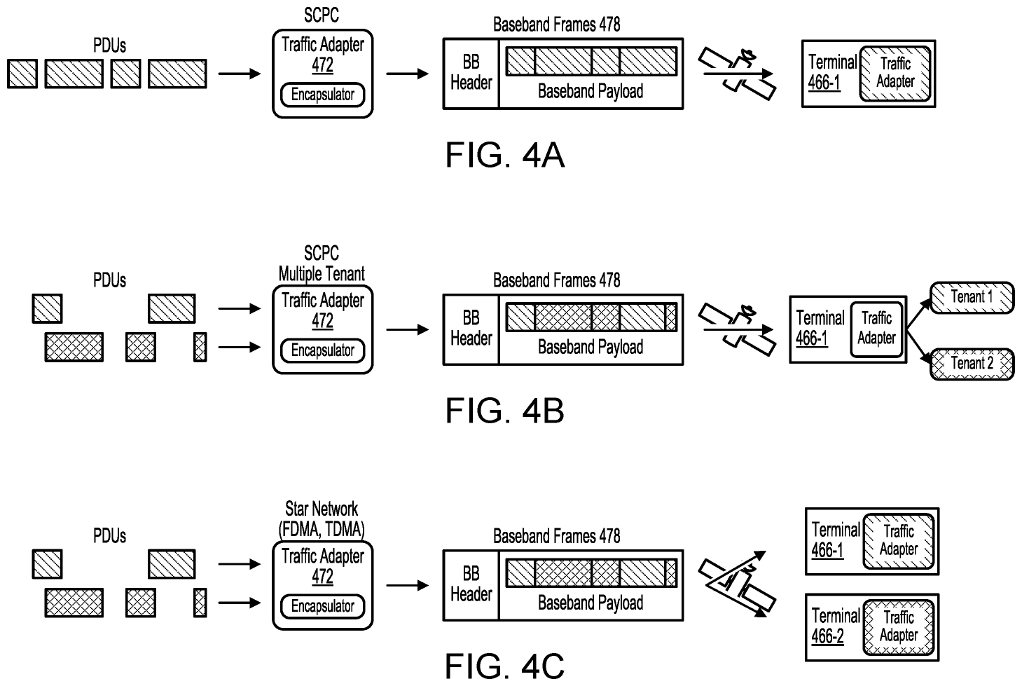

FIGS. 4A-4C illustrate example traffic adapters 472 implementing different network types, in accordance with some embodiments of the present disclosure. In FIG. 4A, traffic adapter 472 is configured by the management system to implement a SCPC (single tenant) network connection type. The encapsulator processes incoming PDUs destined for a terminal 466-1 by encapsulating the PDUs into a baseband frame 478 and adding an encapsulation header to each PDU and a baseband header to the entire baseband frame 478. The encapsulation headers (based on ETSI TS 102 606) include an identifier for terminal 466-1, an identifier of the encapsulated PDU's type, and an indicator of the length of the PDU. They may further include information to allow splitting an encapsulated PDU into multiple fragments to be distributed over multiple baseband frames 478. The baseband header includes, among other elements, information about the contained encapsulation structure and the total size of the payload. Upon receiving baseband frame 478, a traffic adapter of terminal 466-1 may decapsulate the baseband frame to recover the PDUs.

In FIG. 4B, traffic adapter 472 is configured by the management system to implement a SCPC (multiple tenant) network connection type. The encapsulator processes a first set of PDUs destined for Tenant 1 via terminal 466-1 and a second set of PDUs destined for Tenant 2 via terminal 466-1 by encapsulating both sets of PDUs (received within a particular time window) into a single baseband frame 478 and adding a baseband header to baseband frame 478 and individual encapsulation headers to each PDU. The encapsulation headers may include an identifier for Tenant 1, an identifier for Tenant 2, an indicator of the encapsulated PDU's content, an indicator of the size of the encapsulated PDU, and information about fragmentation of the encapsulated PDU across multiple baseband frames 478, among other possibilities. The baseband header includes, among other elements, information about the contained encapsulation structure and the total size of the payload. Upon receiving baseband frame 478, the traffic adapter of terminal 466-1 may decapsulate baseband frame 478 to recover and separate the PDUs, and may route the PDUstoward Tenant 1 and Tenant 2 as appropriate.

In FIG. 4C, traffic adapter 472 is configured by the management system to implement an FDMA or TDMA network connection type. The encapsulator processes a first set of PDUs destined for terminal 466-1 and a second set of PDUs destined for terminal 466-2 by encapsulating both sets of PDUs (received within a particular time window) into a single baseband frame 478 and adding a baseband header to baseband frame 478 and individual encapsulation headers to each PDU. The encapsulation headers include an identifier for terminal 366-1, an identifier for terminal 366-2, an indicator of the encapsulated PDU's content, an indicator of the size of the encapsulated PDU, and information about fragmentation of the encapsulated PDU across multiple baseband frames 478, among other possibilities. They may further include information to allow splitting an encapsulated PDU into multiple fragments to be distributed over multiple baseband frames 478. The baseband header includes, among other elements, information about the contained encapsulation structure and the total size of the payload. Upon receiving baseband frame 478, the traffic adapter of terminal 466-1 may decapsulate baseband frame 478 to recover the PDUs destined for terminal 466-1, and the traffic adapter of terminal 466-2 may decapsulate baseband frame 478 to recover the PDUs destined for terminal 466-2.

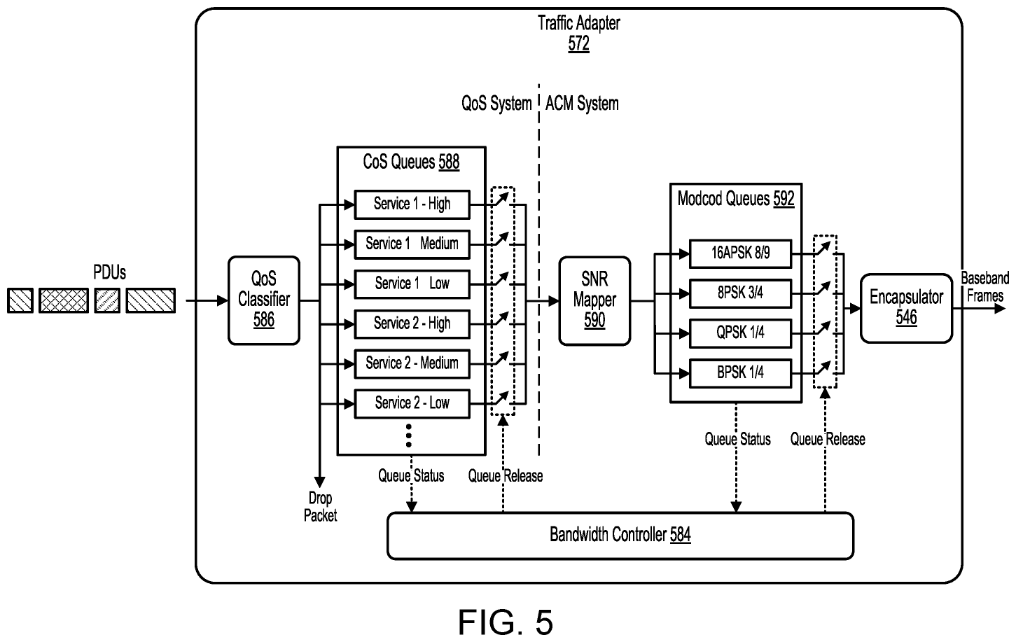

FIG. 5 illustrates an example functionality of a traffic adapter 572 to provide carrier Ethernet services over satellite, in accordance with some embodiments of the present disclosure. In the illustrated example, traffic adapter 572 receives Ethernet frames which are to be encapsulated as baseband frames for transmission to one or more terminals over a satellite link. Prior to encapsulation, the Ethernet frames are passed through a QoS system and an ACM system, each including a respective set of queues for temporarily storing the Ethernet frames. Namely, the QoS system includes a set of CoS queues 588 each storing Ethernet frames for a different CoS, and the ACM system includes a set of Modcod queues each storing Ethernet frames for a different Modcod scheme.

The PDUs input into the QoS system are fed into a QoS classifier 586 that assigns a CoS to each of the data packets (e.g., High, Medium, Low, etc.), thereby generating a set of CoS assignments. Each CoS may have particular performance requirements, such as latency, jitter, and loss rates. QoS classifier 586 may further determine a service identifier (e.g., Service 1, Service 2, Service 3, etc.) for each of the PDUs. QoS classifier 586 may mark each PDU with the assigned CoS and service identifier. For example, QoS classifier 586 can modify the packet header to identify the assigned CoS using fields such as the Differentiated Services Code Point (DSCP) in the IP header or the 802.1p priority field in the Ethernet header.

The QoS system attempts to store each PDU with an assigned CoS into its corresponding one of CoS queues 588. For example, the QoS system may attempt to store a first PDU (e.g., carrying Voice over Internet Protocol (VOIP) data) assigned a service identifier of Service 1 and a CoS of High into the “Service 1-High” queue and a second PDU (e.g., carrying email data) assigned a service identifier of Service 1 and a CoS of Low into the “Service 1-Low” queue. If these queues are full, the QoS system may decide to drop the PDUs or to wait until space within the queues becomes available.

PDUs released by the QoS system from CoS queues 588 are fed into the ACM system, which may include an SNR mapper 590 that assigns a Modcod scheme to each PDU based on satellite link conditions to the destination terminal. The ACM system may continuously monitor various parameters related to the satellite link conditions. These parameters may include signal-to-noise ratio (SNR), bit error rate (BER), received signal strength, and other relevant metrics. Based on these real-time measurements of the satellite link conditions, SNR mapper 590 makes decisions on the most suitable Modcod scheme for the current state of the communication channel.

Each PDU input to SNR mapper 590 may be assigned a Modcod scheme including a modulation scheme or a coding rate, where the modulation scheme indicates how information is encoded onto the carrier signal (e.g., 16APSK, 8PSK, QPSK, BPSK, etc.) and the coding rate refers to the level of error correction applied to the transmitted data (e.g., 8/9, 3/4, 1/4, 1/4, etc.). In general, more robust coding and modulation schemes are used under challenging conditions to ensure accurate data recovery at the receiving end, while more bandwidth-efficient schemes are employed when the satellite link quality is good. For example, higher-order modulation schemes (which transmit more data per symbol) are used when the link conditions allow for it.

The ACM system attempts to store each PDU with an assigned Modcod scheme into its corresponding one of Modcod queues 592. For example, the Modcod system may attempt to store a first PDU (e.g., to be transmitted over a link with good conditions) assigned a Modcod scheme of “16APSK 8/9” into the “16APSK 8/9” queue and a second PDU (e.g., to be transmitted over a link with poor conditions) assigned a Modcod scheme of “16APSK 8/9” into the “16APSK 8/9” queue. If the assigned queues are full, the ACM system may decide to store the PDUs in a queue with a lower-level Modcod scheme. For example, if the “16APSK 8/9” queue is full, the ACM system may store the first PDU in the “8PSK 3/4” queue. PDUs released by the ACM system from Modcod queues 592 are fed into encapsulator 546, which encapsulates the PDUs to produce baseband frames for transmission in the satellite communication system.

Traffic adapter 572 may utilize a bandwidth controller 584 to control the storage and release of PDUs at CoS queues 588 and Modcod queues 592. Bandwidth controller 584 may primarily be used to implement a feedback functionality that instructs the QoS system regarding how much data can be released from CoS queues 588 based on an available bandwidth in Modcod queues 592. In some instances, bandwidth controller 584 may determine an available bandwidth in Modcod queues 592 based on the number/size of PDUs that are currently stored and the total storage capacity of Modcod queues 592. The available bandwidth may then be allocated amongst CoS queues 588, either by bandwidth controller 584 sending the available bandwidth to the QoS system which can make the allocation, or directly by bandwidth controller 584. The QoS system may make decisions about what to prioritize or deprioritize when allocating the available bandwidth to CoS queues 588. After allocation, a portion of the PDUs stored in CoS queues 588 may be released in accordance with the allocated available bandwidth.

In some examples, the available bandwidth may be allocated proportionally based on the number of guaranteed PDUs that are stored in each of CoS queues 588. A PDU is guaranteed if it is subject to performance level expectations, such as limitations on allowed latency and jitter. For example, a first queue of CoS queues 588 storing twice the number of guaranteed PDUs as a second queue of CoS queues 588 may be allocated twice the available bandwidth as the second queue. In some examples, once all of the guaranteed PDUs have been released from CoS queues 588, any available bandwidth that remains may be allocated proportionally based on the number of non-guaranteed PDUs that are stored in each of CoS queues 588.

Some benefits of the disclosed examples are obtained by keeping Modcod queues small and using the feedback loop to inform the QoS system how many PDUs can be released from CoS queues 588 into the ACM system. In some examples, PDUs that have entered the ACM system are prevented from being dropped, such that any packet dropping is restricted to the QoS system. The is possible since the QoS system only releases PDUs from CoS queues 588 to the extent that there is space available in Modcod queues 592.

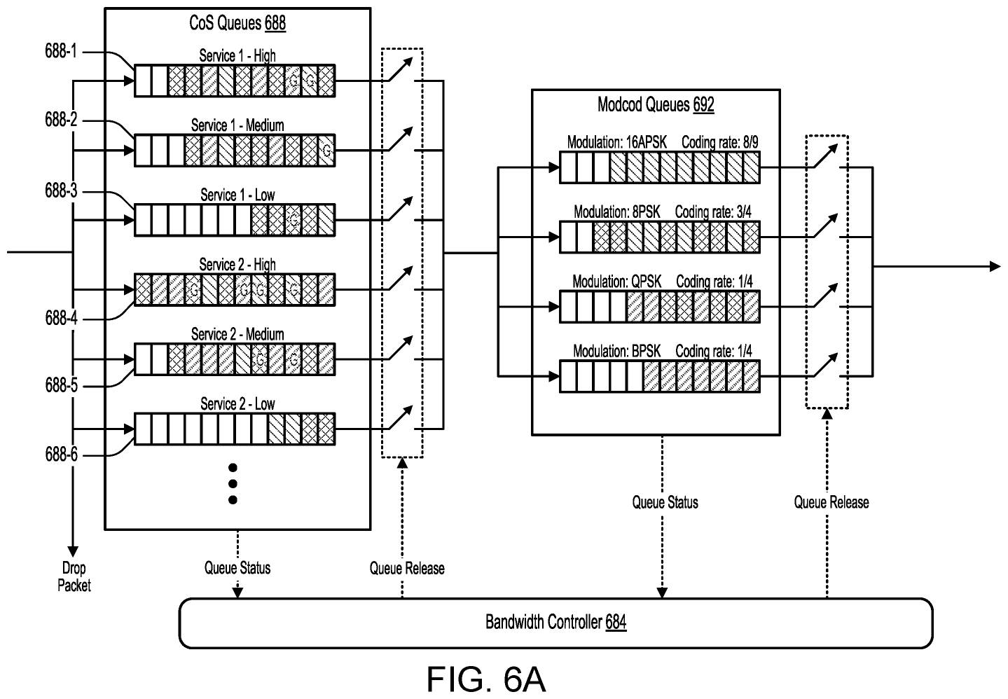

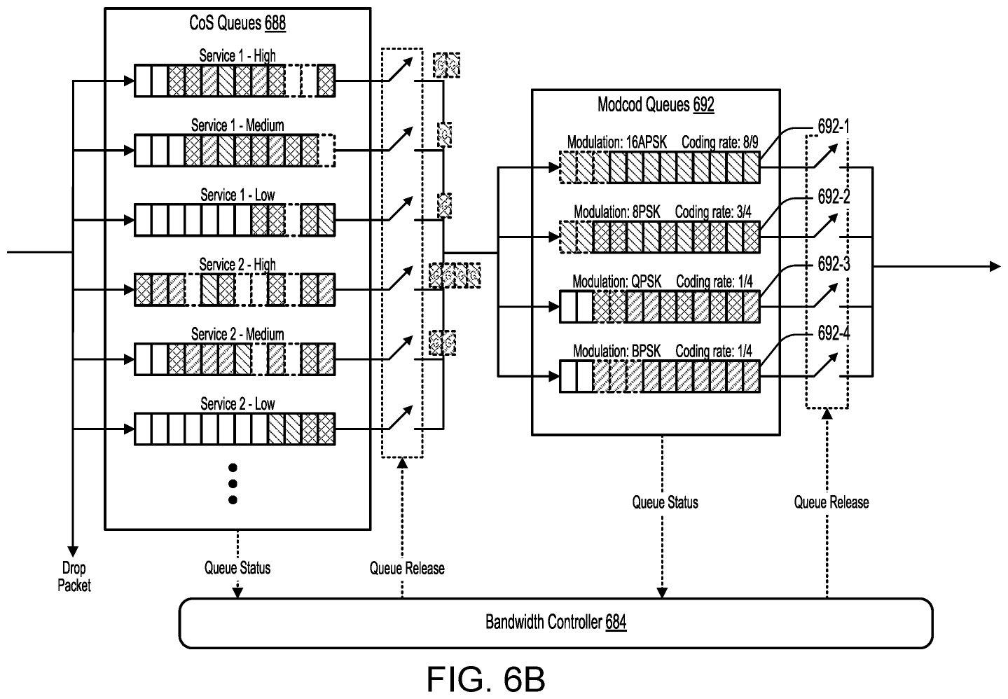

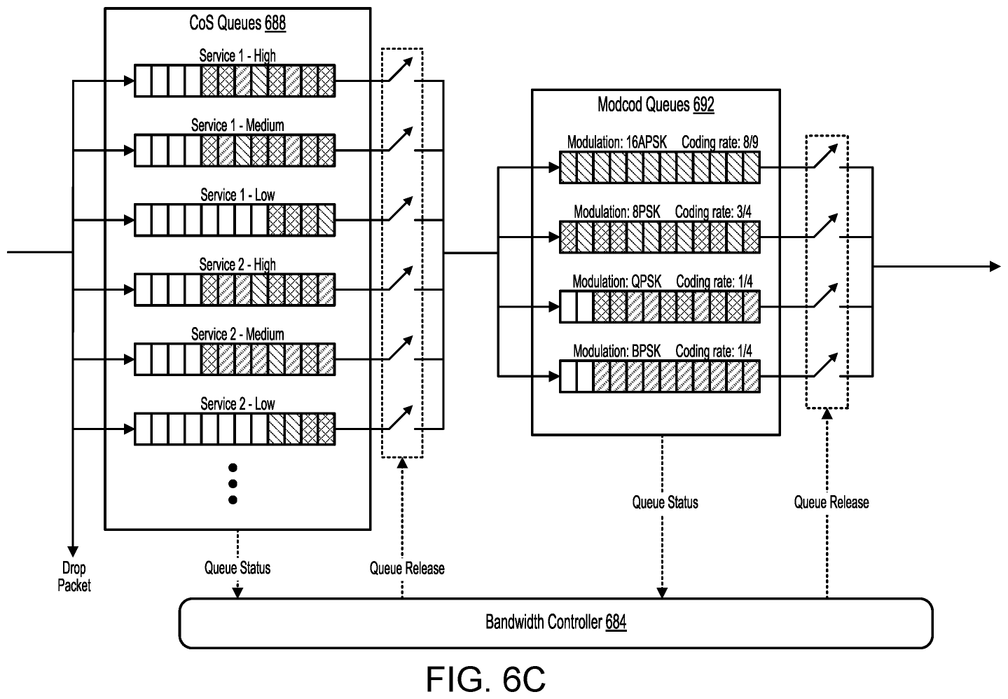

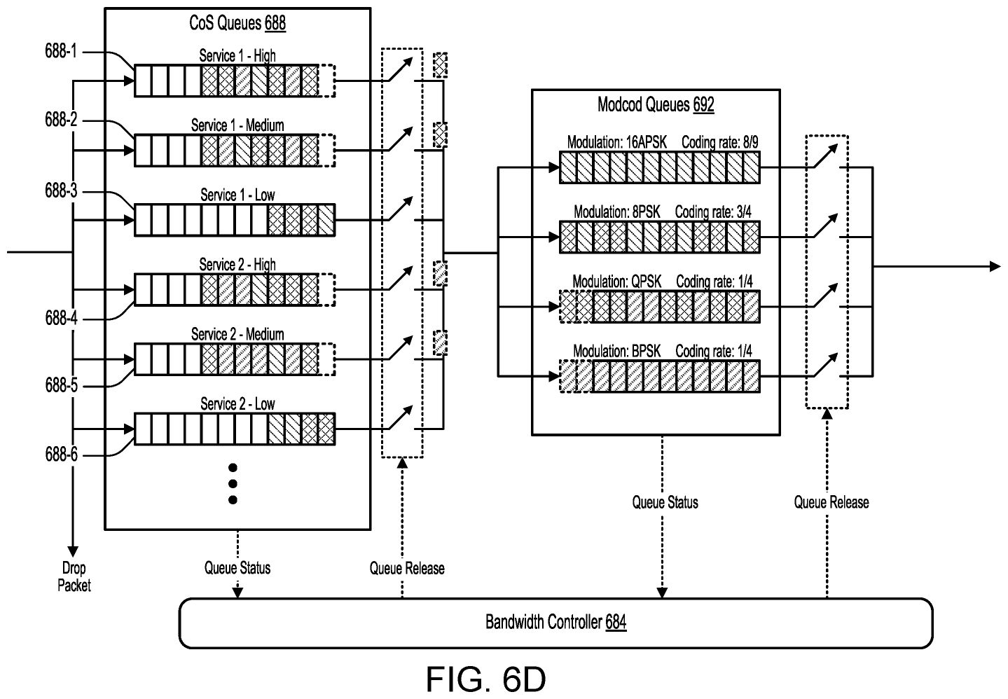

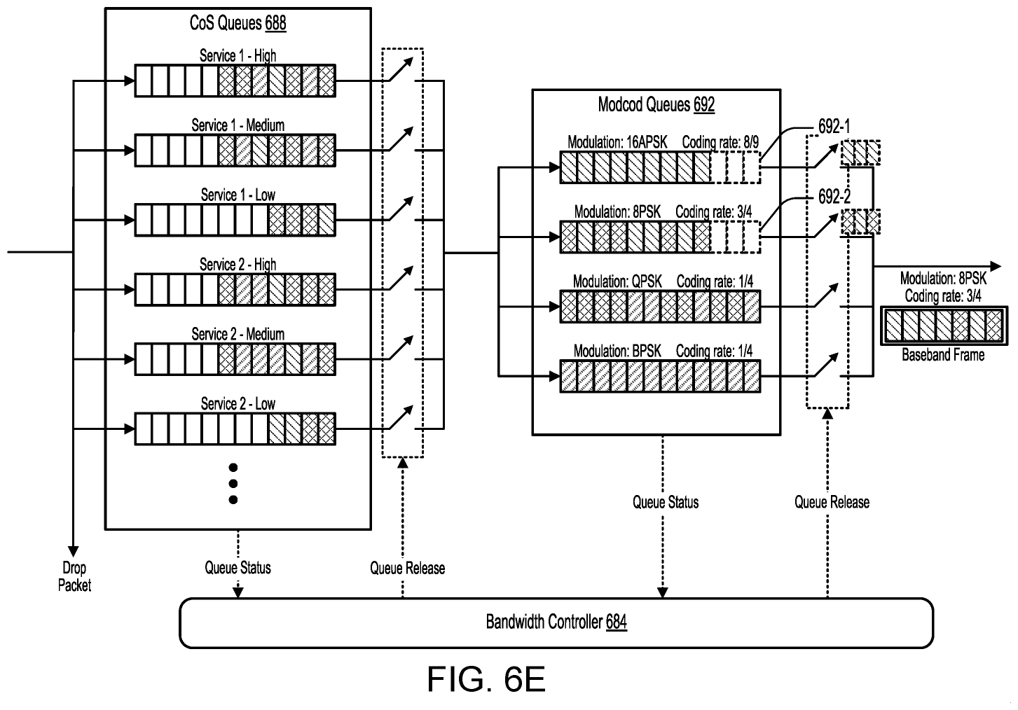

FIGS. 6A-6E illustrate example steps for managing queues for transmission of PDUs in a satellite communication system, in accordance with some embodiments of the present disclosure. In some examples, a traffic adapter includes a set of CoS queues 688, a set of Modcod queues 692, and a bandwidth controller 684 as described in FIG. 5. PDUs input into CoS queues 688 may be stored in accordance with a set of CoS assignments for the PDUs. PDUs may be classified as guaranteed PDUs (marked with “G” in FIGS. 6A-6E) or non-guaranteed PDUs by the traffic adaptor's QoS classifier, according to MEF Carrier Ethernet QoS and Bandwidth Profile standards.

In FIG. 6A, bandwidth controller 684 determines that the available bandwidth in Modcod queues 692 is 14 KB (assuming each entry in Modcod queues 692 and CoS queues 688 stores a 1 kB PDU). Bandwidth controller 684 may, for example, count the number of PDUs currently stored in Modcod queues 692 (i.e., 34 entries or 34 KB of packet data) and estimate how much data can be released by the Modcod queues 692 over the next time interval-48 kB in this example. Bandwidth controller 684 may then allocate the available bandwidth amongst CoS queues 688 based on the number of guaranteed packets that are stored in each of CoS queues 688. In the illustrated example, CoS queue 688-1 has 2 guaranteed PDUs, CoS queue 688-2 has 1 guaranteed PDU, CoS queue 688-3 has 1 guaranteed PDU, CoS queue 688-4 has 4 guaranteed PDUs, CoS queue 688-5 has 2 guaranteed PDUs, and CoS queue 688-6 has 0 guaranteed PDUs. As such, CoS queues 688-1, 688-2, 688-3, 688-4, 688-5, and 688-6 are respectively allocated 2/10 (20%), 1/10 (10%), 1/10 (10%), 4/10 (40%), 2/10 (20%), and 0/10 (0%) of the 14 kB of available bandwidth.

In FIG. 6B, bandwidth controller 684 releases guaranteed PDUs that are stored in each of CoS queues 688 in accordance with the allocated available bandwidth. In this particular example, all guaranteed PDUs are released and are subsequently loaded into Modcod queues 692 in accordance with a set of Modcod scheme assignments for the PDUs. Each Modcod assignment may be based on the channel condition (e.g., signal-to-noise ratio of the communication channel) between the gateway and the terminal to which the particular PDU is to be transmitted. In the illustrated example, 3 PDUs are assigned a 16APSK modulation scheme and a 8/9 coding rate and are accordingly stored in Modcod queue 692-1, 2 PDUs are assigned an 8PSK modulation scheme and a 3/4 coding rate and are accordingly stored in Modcod queue 692-2, 2 PDUs are assigned a QPSK modulation scheme and a 1/4 coding rate and are accordingly stored in Modcod queue 692-3, and 3 PDUs are assigned a BPSK modulation scheme and a 1/4 coding rate and are accordingly stored in Modcod queue 692-4.

In FIG. 6C, bandwidth controller 684 allocates the remaining available bandwidth amongst CoS queues 688 based on the number of non-guaranteed packets that are stored in each of CoS queues 688. In the illustrated example, CoS queue 688-1 has 8 non-guaranteed PDUs, CoS queue 688-2 has 8 non-guaranteed PDUs, CoS queue 688-3 has 4 non-guaranteed PDUs, CoS queue 688-4 has 8 non-guaranteed PDUs, CoS queue 688-5 has 8 non-guaranteed PDUs, and CoS queue 688-6 has 4 non-guaranteed PDUs. As such, CoS queues 688-1, 688-2, 688-3, 688-4, 688-5, and 688-6 are respectively allocated 8/40 (20%), 8/40 (20%), 4/40 (10%), 8/40 (20%), 8/40 (20%), and 4/40 (10%) of the 4 kB of remaining available bandwidth.

In FIG. 6D, bandwidth controller 684 releases non-guaranteed PDUs that are stored in each of CoS queues 688 in accordance with the allocated remaining available bandwidth. In this particular example, 1 PDU is released from each of CoS queues 688-1, 688-2, 688-4, and 688-5, all of which are then loaded into Modcod queues 692 in accordance with a set of Modcod scheme assignments for the PDUs. As the PDUs are loaded into the Modcod queues 692, they are interleaved with the guaranteed PDUs such that the original sequence of PDUs is maintained. In the illustrated example, 2 PDUs are assigned a QPSK modulation scheme and a 1/4 coding rate and are accordingly stored in Modcod queue 692-3, and 2 PDUs are assigned a BPSK modulation scheme and a 1/4 coding rate and are accordingly stored in Modcod queue 692-4.

In FIG. 6E, PDUs stored in Modcod queues 692 are released to form a baseband frame for transmission to one or more terminals. The ACM system may determine that the baseband frame will be assigned an 8PSK modulation scheme and a 3/4 coding rate and thus PDUs assigned that Modcod scheme or a higher-level Modcod scheme (e.g., 16APSK 8/9) will be suitable for inclusion in the baseband frame. In the illustrated example, 3 PDUs are released from each of Modcod queues 692-1 and 692-2 for inclusion in the baseband frame. The steps shown in FIGS. 6A-6E may be repeated at each of multiple time steps, with reevaluated channel conditions and Modcod assignments for particular terminals.

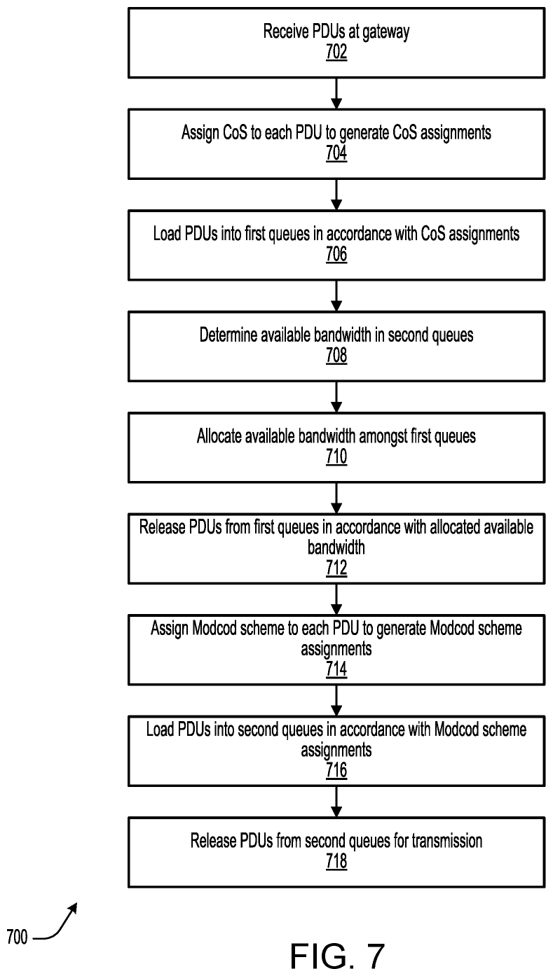

FIG. 7 illustrates a method 700 of managing queues for transmission of PDUs in a satellite communication system, in accordance with some embodiments of the present disclosure. Steps of method 700 may be performed in any order and/or in parallel, and one or more steps of method 700 may be optionally performed. One or more steps of method 700 may be performed by one or more processors. Method 700 may be implemented as a computer-readable medium or computer program product comprising instructions which, when the program is executed by one or more processors, cause the one or more processors to carry out the steps of method 700.

At step 702, PDUs are received at a gateway (e.g., gateways 138, 238) of a satellite communication system (e.g., satellite communication systems 100, 200). The gateway may include a compute infrastructure (e.g., compute infrastructure 160) running a set of VNFs (e.g., VNFs 154, 254) including a traffic adapter (e.g., traffic adapters 272, 472, 572). The traffic adapter may include a first set of queues (e.g., CoS queues 588, 688) each corresponding to different CoS and a second set of queues (e.g., Modcod queues 592, 692) each corresponding to a different Modcod scheme.

At step 704, a CoS is assigned to each of the PDUs to generate a set of CoS assignments for the PDUs. The CoS may be assigned by a QoS classifier (e.g., QoS classifier 586).

At step 706, the PDUs are loaded into the first set of queues in accordance with the set of CoS assignments for the PDUs. In some examples, method 700 may further include classification of the PDU by determining applicable service level guarantees for the PDUs. In some examples, the applicable service level guarantees for the PDUs are determined based on MEF Carrier Ethernet service definitions.

At step 708, the available bandwidth in the second set of queues is determined based on a number of the PDUs and their respective sizes that are stored in each of the second set of queues. The available bandwidth in the second set of queues may be determined by a bandwidth controller (e.g., bandwidth controller 584).

At step 710, the available bandwidth in the second set of queues is allocated amongst the first set of queues. The available bandwidth in the second set of queues may be allocated by counting a number of guaranteed PDUs that are stored in each of the first set of queues and allocating the available bandwidth proportionally amongst the first set of queues based on the number of guaranteed PDUs and their respective sizes in each of the first set of queues.

At step 712, the PDUs are released from the first set of queues in accordance with the allocated available bandwidth.

At step 714, a Modcod scheme is assigned to each of the PDUs to generate a set of Modcod scheme assignments for the PDUs. Each of the set of Modcod scheme assignments may include one or both of a modulation scheme assignment or a coding rate assignment. The Modcod scheme may be assigned by an SNR mapper (e.g., SNR mapper 590).

At step 716, the PDUs are loaded into the second set of queues in accordance with the set of Modcod scheme assignments for the PDUs.

At step 718, the PDUs are released from the second set of queues for transmission in the satellite communication system. In some examples, after releasing the PDUs from the second set of queues, the PDUs are encapsulated to produce baseband frames (e.g., baseband frames 278, 378, 478).

FIG. 5 illustrates an example functionality of a traffic adapter 572 to provide carrier Ethernet services over satellite, in accordance with some embodiments of the present disclosure. In the illustrated example, traffic adapter 572 receives Ethernet frames which are to be encapsulated as baseband frames for transmission to one or more terminals over a satellite link. Prior to encapsulation, the Ethernet frames are passed through a QoS system and an ACM system, each including a respective set of queues for temporarily storing the Ethernet frames. Namely, the QoS system includes a set of CoS queues 588 each storing Ethernet frames for a different CoS, and the ACM system includes a set of Modcod queues each storing Ethernet frames for a different Modcod scheme.

The PDUs input into the QoS system are fed into a QoS classifier 586 that assigns a CoS to each of the data packets (e.g., High, Medium, Low, etc.), thereby generating a set of CoS assignments. Each CoS may have particular performance requirements, such as latency, jitter, and loss rates. QoS classifier 586 may further determine a service identifier (e.g., Service 1, Service 2, Service 3, etc.) for each of the PDUs. QoS classifier 586 may mark each PDU with the assigned CoS and service identifier. For example, QoS classifier 586 can modify the packet header to identify the assigned CoS using fields such as the Differentiated Services Code Point (DSCP) in the IP header or the 802.1p priority field in the Ethernet header.

The QoS system attempts to store each PDU with an assigned CoS into its corresponding one of CoS queues 588. For example, the QoS system may attempt to store a first PDU (e.g., carrying Voice over Internet Protocol (VOIP) data) assigned a service identifier of Service 1 and a CoS of High into the “Service 1-High” queue and a second PDU (e.g., carrying email data) assigned a service identifier of Service 1 and a CoS of Low into the “Service 1-Low” queue. If these queues are full, the QoS system may decide to drop the PDUs or to wait until space within the queues becomes available.

PDUs released by the QoS system from CoS queues 588 are fed into the ACM system, which may include an SNR mapper 590 that assigns a Modcod scheme to each PDU based on satellite link conditions to the destination terminal. The ACM system may continuously monitor various parameters related to the satellite link conditions. These parameters may include signal-to-noise ratio (SNR), bit error rate (BER), received signal strength, and other relevant metrics. Based on these real-time measurements of the satellite link conditions, SNR mapper 590 makes decisions on the most suitable Modcod scheme for the current state of the communication channel.

Each PDU input to SNR mapper 590 may be assigned a Modcod scheme including a modulation scheme or a coding rate, where the modulation scheme indicates how information is encoded onto the carrier signal (e.g., 16APSK, 8PSK, QPSK, BPSK, etc.) and the coding rate refers to the level of error correction applied to the transmitted data (e.g., 8/9, 3/4, 1/4, 1/4, etc.). In general, more robust coding and modulation schemes are used under challenging conditions to ensure accurate data recovery at the receiving end, while more bandwidth-efficient schemes are employed when the satellite link quality is good. For example, higher-order modulation schemes (which transmit more data per symbol) are used when the link conditions allow for it.

The ACM system attempts to store each PDU with an assigned Modcod scheme into its corresponding one of Modcod queues 592. For example, the Modcod system may attempt to store a first PDU (e.g., to be transmitted over a link with good conditions) assigned a Modcod scheme of “16APSK 8/9” into the “16APSK 8/9” queue and a second PDU (e.g., to be transmitted over a link with poor conditions) assigned a Modcod scheme of “16APSK 8/9” into the “16APSK 8/9” queue. If the assigned queues are full, the ACM system may decide to store the PDUs in a queue with a lower-level Modcod scheme. For example, if the “16APSK 8/9” queue is full, the ACM system may store the first PDU in the “8PSK 3/4” queue. PDUs released by the ACM system from Modcod queues 592 are fed into encapsulator 546, which encapsulates the PDUs to produce baseband frames for transmission in the satellite communication system.

Traffic adapter 572 may utilize a bandwidth controller 584 to control the storage and release of PDUs at CoS queues 588 and Modcod queues 592. Bandwidth controller 584 may primarily be used to implement a feedback functionality that instructs the QoS system regarding how much data can be released from CoS queues 588 based on an available bandwidth in Modcod queues 592. In some instances, bandwidth controller 584 may determine an available bandwidth in Modcod queues 592 based on the number/size of PDUs that are currently stored and the total storage capacity of Modcod queues 592. The available bandwidth may then be allocated amongst CoS queues 588, either by bandwidth controller 584 sending the available bandwidth to the QoS system which can make the allocation, or directly by bandwidth controller 584. The QoS system may make decisions about what to prioritize or deprioritize when allocating the available bandwidth to CoS queues 588. After allocation, a portion of the PDUs stored in CoS queues 588 may be released in accordance with the allocated available bandwidth.

In some examples, the available bandwidth may be allocated proportionally based on the number of guaranteed PDUs that are stored in each of CoS queues 588. A PDU is guaranteed if it is subject to performance level expectations, such as limitations on allowed latency and jitter. For example, a first queue of CoS queues 588 storing twice the number of guaranteed PDUs as a second queue of CoS queues 588 may be allocated twice the available bandwidth as the second queue. In some examples, once all of the guaranteed PDUs have been released from CoS queues 588, any available bandwidth that remains may be allocated proportionally based on the number of non-guaranteed PDUs that are stored in each of CoS queues 588.

Some benefits of the disclosed examples are obtained by keeping Modcod queues small and using the feedback loop to inform the QoS system how many PDUs can be released from CoS queues 588 into the ACM system. In some examples, PDUs that have entered the ACM system are prevented from being dropped, such that any packet dropping is restricted to the QoS system. The is possible since the QoS system only releases PDUs from CoS queues 588 to the extent that there is space available in Modcod queues 592.

FIGS. 6A-6E illustrate example steps for managing queues for transmission of PDUs in a satellite communication system, in accordance with some embodiments of the present disclosure. In some examples, a traffic adapter includes a set of CoS queues 688, a set of Modcod queues 692, and a bandwidth controller 684 as described in FIG. 5. PDUs input into CoS queues 688 may be stored in accordance with a set of CoS assignments for the PDUs. PDUs may be classified as guaranteed PDUs (marked with “G” in FIGS. 6A-6E) or non-guaranteed PDUs by the traffic adaptor's QoS classifier, according to MEF Carrier Ethernet QoS and Bandwidth Profile standards.

In FIG. 6A, bandwidth controller 684 determines that the available bandwidth in Modcod queues 692 is 14 KB (assuming each entry in Modcod queues 692 and CoS queues 688 stores a 1 kB PDU). Bandwidth controller 684 may, for example, count the number of PDUs currently stored in Modcod queues 692 (i.e., 34 entries or 34 KB of packet data) and estimate how much data can be released by the Modcod queues 692 over the next time interval-48 KB in this example. Bandwidth controller 684 may then allocate the available bandwidth amongst CoS queues 688 based on the number of guaranteed packets that are stored in each of CoS queues 688. In the illustrated example, CoS queue 688-1 has 2 guaranteed PDUs, CoS queue 688-2 has 1 guaranteed PDU, CoS queue 688-3 has 1 guaranteed PDU, CoS queue 688-4 has 4 guaranteed PDUs, CoS queue 688-5 has 2 guaranteed PDUs, and CoS queue 688-6 has 0 guaranteed PDUs. As such, CoS queues 688-1, 688-2, 688-3, 688-4, 688-5, and 688-6 are respectively allocated 2/10 (20%), 1/10 (10%), 1/10 (10%), 4/10 (40%), 2/10 (20%), and 0/10 (0%) of the 14 kB of available bandwidth.

In FIG. 6B, bandwidth controller 684 releases guaranteed PDUs that are stored in each of CoS queues 688 in accordance with the allocated available bandwidth. In some examples, the PDUs are released in order from each of CoS queues 688, whether guaranteed or non-guaranteed. In the illustrated example, all guaranteed PDUs are first released and are subsequently loaded into Modcod queues 692 in accordance with a set of Modcod scheme assignments for the PDUs. Each Modcod assignment may be based on the channel condition (e.g., signal-to-noise ratio of the communication channel) between the gateway and the terminal to which the particular PDU is to be transmitted. In the illustrated example, 3 PDUs are assigned a 16APSK modulation scheme and a 8/9 coding rate and are accordingly stored in Modcod queue 692-1, 2 PDUs are assigned an 8PSK modulation scheme and a 3/4 coding rate and are accordingly stored in Modcod queue 692-2, 2 PDUs are assigned a QPSK modulation scheme and a 1/4 coding rate and are accordingly stored in Modcod queue 692-3, and 3 PDUs are assigned a BPSK modulation scheme and a 1/4 coding rate and are accordingly stored in Modcod queue 692-4.

In FIG. 6C, bandwidth controller 684 allocates the remaining available bandwidth amongst CoS queues 688 based on the number of non-guaranteed packets that are stored in each of CoS queues 688. In the illustrated example, CoS queue 688-1 has 8 non-guaranteed PDUs, CoS queue 688-2 has 8 non-guaranteed PDUs, CoS queue 688-3 has 4 non-guaranteed PDUs, CoS queue 688-4 has 8 non-guaranteed PDUs, CoS queue 688-5 has 8 non-guaranteed PDUs, and CoS queue 688-6 has 4 non-guaranteed PDUs. As such, CoS queues 688-1, 688-2, 688-3, 688-4, 688-5, and 688-6 are respectively allocated 8/40 (20%), 8/40 (20%), 4/40 (10%), 8/40 (20%), 8/40 (20%), and 4/40 (10%) of the 4 KB of remaining available bandwidth.

In FIG. 6D, bandwidth controller 684 releases non-guaranteed PDUs that are stored in each of CoS queues 688 in accordance with the allocated remaining available bandwidth. In this particular example, 1 PDU is released from each of CoS queues 688-1, 688-2, 688-4, and 688-5, all of which are then loaded into Modcod queues 692 in accordance with a set of Modcod scheme assignments for the PDUs. In some examples, as the PDUs are loaded into the Modcod queues 692, they may be interleaved with the guaranteed PDUs such that the original sequence of PDUs is maintained. In the illustrated example, 2 PDUs are assigned a QPSK modulation scheme and a 1/4 coding rate and are accordingly stored in Modcod queue 692-3, and 2 PDUs are assigned a BPSK modulation scheme and a 1/4 coding rate and are accordingly stored in Modcod queue 692-4.

In FIG. 6E, PDUs stored in Modcod queues 692 are released to form a baseband frame for transmission to one or more terminals. The ACM system may determine that the baseband frame will be assigned an 8PSK modulation scheme and a 3/4 coding rate and thus PDUs assigned that Modcod scheme or a higher-level Modcod scheme (e.g., 16APSK 8/9) will be suitable for inclusion in the baseband frame. In the illustrated example, 3 PDUs are released from each of Modcod queues 692-1 and 692-2 for inclusion in the baseband frame. The steps shown in FIGS. 6A-6E may be repeated at each of multiple time steps, with reevaluated channel conditions and Modcod assignments for particular terminals.

FIG. 7 illustrates a method 700 of managing queues for transmission of PDUs in a satellite communication system, in accordance with some embodiments of the present disclosure. Steps of method 700 may be performed in any order and/or in parallel, and one or more steps of method 700 may be optionally performed. One or more steps of method 700 may be performed by one or more processors. Method 700 may be implemented as a computer-readable medium or computer program product comprising instructions which, when the program is executed by one or more processors, cause the one or more processors to carry out the steps of method 700.

At step 702, PDUs are received at a gateway (e.g., gateways 138, 238) of a satellite communication system (e.g., satellite communication systems 100, 200). The gateway may include a compute infrastructure (e.g., compute infrastructure 160) running a set of VNFs (e.g., VNFs 154, 254) including a traffic adapter (e.g., traffic adapters 272, 472, 572). The traffic adapter may include a first set of queues (e.g., CoS queues 588, 688) each corresponding to different CoS and a second set of queues (e.g., Modcod queues 592, 692) each corresponding to a different Modcod scheme. The PDUs may include Ethernet frames, IP packets, TCP segments, UDP datagrams, among other possibilities.

At step 704, a CoS is assigned to each of the PDUs to generate a set of CoS assignments for the PDUs. The CoS may be assigned by a QoS classifier (e.g., QoS classifier 586).

At step 706, the PDUs are loaded into the first set of queues in accordance with the set of CoS assignments for the PDUs. In some examples, method 700 may include further classification of the PDUs, for example using a MEF Carrier Ethernet Bandwidth Profile to determine whether each PDU is subject to performance level guarantees. Such PDUs may be classified as guaranteed PDUs.

At step 708, the available bandwidth in the second set of queues is determined based on a number of the PDUs that are stored in each of the second set of queues. The available bandwidth in the second set of queues may be determined by a bandwidth controller (e.g., bandwidth controller 584).

At step 710, the available bandwidth in the second set of queues is allocated amongst the first set of queues. The available bandwidth in the second set of queues may be allocated by counting a number of guaranteed PDUs that are stored in each of the first set of queues and allocating the available bandwidth proportionally amongst the first set of queues based on the number of guaranteed PDUs in each of the first set of queues.

At step 712, the PDUs are released from the first set of queues in accordance with the allocated available bandwidth. In some examples, the PDUs may be released from the first set of queues in FIFO order (treating guaranteed PDUs and non-guaranteed PDUs similarly) to maintain the original sequence of the PDUs. In some examples, guaranteed PDUs may be released from the first set of queues first, followed by non-guaranteed PDUs.

At step 714, a Modcod scheme is assigned to each of the PDUs to generate a set of Modcod scheme assignments for the PDUs. Each of the set of Modcod scheme assignments may include one or both of a modulation scheme assignment or a coding rate assignment. The Modcod scheme may be assigned by an SNR mapper (e.g., SNR mapper 590).

At step 716, the PDUs are loaded into the second set of queues in accordance with the set of Modcod scheme assignments for the PDUs.

At step 718, the PDUs are released from the second set of queues for transmission in the satellite communication system. In some examples, after releasing the PDUs from the second set of queues, the PDUs are encapsulated to produce baseband frames (e.g., baseband frames 278, 378, 478).

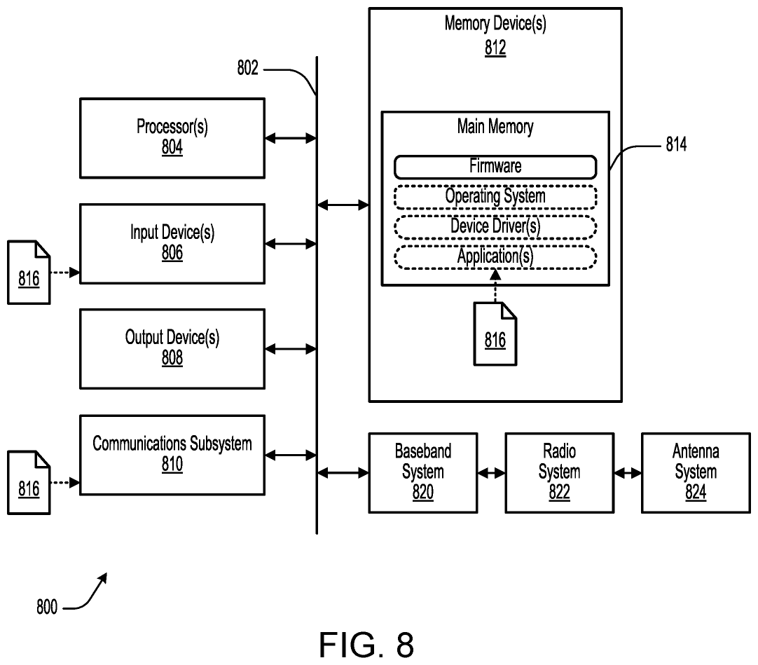

FIG. 8 illustrates an example computer system 800 comprising various hardware elements, in accordance with some embodiments of the present disclosure. Computer system 800 may be incorporated into or integrated with devices described herein and/or may be configured to perform some or all of the steps of the methods provided by various embodiments. It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner.

In the illustrated example, computer system 800 includes a communication medium 802, one or more processor(s) 804, one or more input device(s) 806, one or more output device(s) 808, a communications subsystem 810, one or more memory device(s) 812, a baseband system 820, a radio system 822, and an antenna system 824. Computer system 800 may be implemented using various hardware implementations and embedded system technologies. For example, one or more elements of computer system 800 may be implemented within an integrated circuit (IC), an application-specific integrated circuit (ASIC), an application-specific standard product (ASSP), a field-programmable gate array (FPGA), such as those commercially available by XILINX®, INTEL®, or LATTICE SEMICONDUCTOR®, a system-on-a-chip (SoC), a microcontroller, a printed circuit board (PCB), and/or a hybrid device, such as an SoC FPGA, among other possibilities.

The various hardware elements of computer system 800 may be communicatively coupled via communication medium 802. While communication medium 802 is illustrated as a single connection for purposes of clarity, it should be understood that communication medium 802 may include various numbers and types of communication media for transferring data between hardware elements. For example, communication medium 802 may include one or more wires (e.g., conductive traces, paths, or leads on a PCB or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 802 may include one or more buses that connect the pins of the hardware elements of computer system 800. For example, communication medium 802 may include a bus that connects processor(s) 804 with main memory 814, referred to as a system bus, and a bus that connects main memory 814 with input device(s) 806 or output device(s) 808, referred to as an expansion bus. The system bus may itself consist of several buses, including an address bus, a data bus, and a control bus. The address bus may carry a memory address from processor(s) 804 to the address bus circuitry associated with main memory 814 in order for the data bus to access and carry the data contained at the memory address back to processor(s) 804. The control bus may carry commands from processor(s) 804 and return status signals from main memory 814. Each bus may include multiple wires for carrying multiple bits of information and each bus may support serial or parallel transmission of data.

Processor(s) 804 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 804 may include one or more multi-core processors, in which each core may read and execute program instructions concurrently with the other cores, increasing speed for programs that support multithreading.

Input device(s) 806 may include one or more of various user input devices such as a mouse, a keyboard, a microphone, as well as various sensor input devices, such as an image capture device, a temperature sensor (e.g., thermometer, thermocouple, thermistor), a pressure sensor (e.g., barometer, tactile sensor), a movement sensor (e.g., accelerometer, gyroscope, tilt sensor), a light sensor (e.g., photodiode, photodetector, charge-coupled device), and/or the like. Input device(s) 806 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 808 may include one or more of various devices that convert information into human-readable form, such as without limitation a display device, a speaker, a printer, a haptic or tactile device, and/or the like. Output device(s) 808 may also include devices for writing to removable storage devices or other removable media, such as those described in reference to input device(s) 806. Output device(s) 808 may also include various actuators for causing physical movement of one or more components. Such actuators may be hydraulic, pneumatic, electric, and may be controlled using control signals generated by computer system 800.

Communications subsystem 810 may include hardware components for connecting computer system 800 to systems or devices that are located external to computer system 800, such as over a computer network. In various embodiments, communications subsystem 810 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 812 may include the various data storage devices of computer system 800. For example, memory device(s) 812 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 804 and memory device(s) 812 are illustrated as being separate elements, it should be understood that processor(s) 804 may include varying levels of on-processor memory, such as processor registers and caches that may be utilized by a single processor or shared between multiple processors.

Memory device(s) 812 may include main memory 814, which may be directly accessible by processor(s) 804 via the address and data buses of communication medium 802. For example, processor(s) 804 may continuously read and execute instructions stored in main memory 814. As such, various software elements may be loaded into main memory 814 to be read and executed by processor(s) 804 as illustrated in FIG. 8. Typically, main memory 814 is volatile memory, which loses all data when power is turned off and accordingly needs power to preserve stored data. Main memory 814 may further include a small portion of non-volatile memory containing software (e.g., firmware, such as BIOS) that is used for reading other software stored in memory device(s) 812 into main memory 814. In some embodiments, the volatile memory of main memory 814 is implemented as RAM, such as dynamic random-access memory (DRAM), and the non-volatile memory of main memory 814 is implemented as read-only memory (ROM), such as flash memory, erasable programmable read-only memory (EPROM), or electrically erasable programmable read-only memory (EEPROM).

Computer system 800 may include software elements, shown as being currently located within main memory 814, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 816, which are executable by computer system 800. In one example, such instructions 816 may be received by computer system 800 using communications subsystem 810 (e.g., via a wireless or wired signal that carries instructions 816), carried by communication medium 802 to memory device(s) 812, stored within memory device(s) 812, read into main memory 814, and executed by processor(s) 804 to perform one or more steps of the described methods. In another example, instructions 816 may be received by computer system 800 using input device(s) 806 (e.g., via a reader for removable media), carried by communication medium 802 to memory device(s) 812, stored within memory device(s) 812, read into main memory 814, and executed by processor(s) 804 to perform one or more steps of the described methods.

Computer system 800 may include optional wireless communication components that facilitate wireless communication over a voice network and/or a data network. The wireless communication components comprise an antenna system 824, a radio system 822, and a baseband system 820. In computer system 800, RF signals are transmitted and received over the air by antenna system 824 under the management of radio system 822. In an embodiment, antenna system 824 may comprise one or more antennae and one or more multiplexors (not shown) that perform a switching function to provide antenna system 824 with transmit and receive signal paths. In the reception path, received RF signals can be coupled from a multiplexor to a low noise amplifier (not shown) that amplifies the received RF signal and sends the amplified signal to radio system 822. In an alternative embodiment, radio system 822 may comprise one or more radios that are configured to communicate over various frequencies. In an embodiment, radio system 822 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 822 to baseband system 820.

In some embodiments of the present disclosure, instructions 816 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 800. For example, the non-transitory computer-readable medium may be one of memory device(s) 812 (as shown in FIG. 8). In some cases, the non-transitory computer-readable medium may be separate from computer system 800. In one example, the non-transitory computer-readable medium may be a removable medium provided to input device(s) 806 (as shown in FIG. 8), such as those described in reference to input device(s) 806, with instructions 816 being read into computer system 800 by input device(s) 806. In another example, the non-transitory computer-readable medium may be a component of a remote electronic device, such as a mobile phone, that may wirelessly transmit a data signal that carries instructions 816 to computer system 800 and that is received by communications subsystem 810 (as shown in FIG. 8).

Instructions 816 may take any suitable form to be read and/or executed by computer system 800. For example, instructions 816 may be source code (written in a human-readable programming language such as Java, C, C++, C#, Python), object code, assembly language, machine code, microcode, executable code, and/or the like. In one example, instructions 816 are provided to computer system 800 in the form of source code, and a compiler is used to translate instructions 816 from source code to machine code, which may then be read into main memory 814 for execution by processor(s) 804. As another example, instructions 816 are provided to computer system 800 in the form of an executable file with machine code that may immediately be read into main memory 814 for execution by processor(s) 804. In various examples, instructions 816 may be provided to computer system 800 in encrypted or unencrypted form, compressed or uncompressed form, as an installation package or an initialization for a broader software deployment, among other possibilities.

In one aspect of the present disclosure, a system (e.g., computer system 800) is provided to perform methods in accordance with various embodiments of the present disclosure. For example, some embodiments may include a system comprising one or more processors (e.g., processor(s) 804) that are communicatively coupled to a non-transitory computer-readable medium (e.g., memory device(s) 812 or main memory 814). The non-transitory computer-readable medium may have instructions (e.g., instructions 816) stored therein that, when executed by the one or more processors, cause the one or more processors to perform the methods described in the various embodiments.

In another aspect of the present disclosure, a computer-program product that includes instructions (e.g., instructions 816) is provided to perform methods in accordance with various embodiments of the present disclosure. The computer-program product may be tangibly embodied in a non-transitory computer-readable medium (e.g., memory device(s) 812 or main memory 814). The instructions may be configured to cause one or more processors (e.g., processor(s) 804) to perform the methods described in the various embodiments.

In another aspect of the present disclosure, a non-transitory computer-readable medium (e.g., memory device(s) 812 or main memory 814) is provided. The non-transitory computer-readable medium may have instructions (e.g., instructions 816) stored therein that, when executed by one or more processors (e.g., processor(s) 804), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of managing queues for transmission of protocol data units (PDUs) in a satellite communication system, the method comprising:
receiving the PDUs at a gateway, the gateway having a first set of queues each corresponding to a different class of service (CoS) and a second set of queues each corresponding to a different modulation and coding (Modcod) scheme;
loading the PDUs into the first set of queues in accordance with a set of CoS assignments for the PDUs;
allocating an available bandwidth in the second set of queues amongst the first set of queues;
releasing the PDUs from the first set of queues in accordance with the allocated available bandwidth;
loading the PDUs into the second set of queues in accordance with a set of Modcod scheme assignments for the PDUs; and
releasing the PDUs from the second set of queues for transmission in the satellite communication system.

2. The method of claim 1, wherein allocating the available bandwidth in the second set of queues amongst the first set of queues includes counting a number of guaranteed PDUs that are stored in each of the first set of queues, wherein the available bandwidth in the second set of queues is allocated proportionally amongst the first set of queues based on the number of guaranteed PDUs and their respective sizes in each of the first set of queues.

3. The method of claim 1, further comprising:
assigning a CoS to each of the PDUs to generate the set of CoS assignments for the PDUs.

4. The method of claim 1, further comprising:
determining applicable service level guarantees for the PDUs.

5. The method of claim 4, wherein the applicable service level guarantees for the PDUs are determined based on MEF Carrier Ethernet service definitions.

6. The method of claim 1, further comprising:
determining the available bandwidth in the second set of queues based on a number of the PDUs and their respective sizes that are stored in each of the second set of queues.

7. The method of claim 1, further comprising:
assigning a Modcod scheme to each of the PDUs to generate the set of Modcod scheme assignments for the PDUs, wherein each of the set of Modcod scheme assignments includes one or both of a modulation scheme assignment or a coding rate assignment.

8. The method of claim 7, wherein the set of Modcod scheme assignments are generated based on an estimated signal-to-noise ratio of a communication channel between the gateway and one or more terminals.

9. The method of claim 1, further comprising:
after releasing the PDUs from the second set of queues, encapsulating the PDUs to produce baseband frames.

10. The method of claim 9, further comprising:
modulating the baseband frames to produce digital waveforms;
digitizing the digital waveforms to produce analog signals; and
transmitting the analog signals to one or more terminals via a satellite.

11. A non-transitory computer-readable medium comprising instructions that, when executed by one or more processors, cause the one or more processors to perform operations for managing queues for transmission of protocol data units (PDUs) in a satellite communication system, the operations comprising:
receiving the PDUs at a gateway, the gateway having a first set of queues each corresponding to a different class of service (CoS) and a second set of queues each corresponding to a different modulation and coding (Modcod) scheme;
loading the PDUs into the first set of queues in accordance with a set of CoS assignments for the PDUs;
allocating an available bandwidth in the second set of queues amongst the first set of queues;
releasing the PDUs from the first set of queues in accordance with the allocated available bandwidth;
loading the PDUs into the second set of queues in accordance with a set of Modcod scheme assignments for the PDUs; and
releasing the PDUs from the second set of queues for transmission in the satellite communication system.

12. The non-transitory computer-readable medium of claim 11, wherein allocating the available bandwidth in the second set of queues amongst the first set of queues includes counting a number of guaranteed PDUs and their respective sizes that are stored in each of the first set of queues, wherein the available bandwidth in the second set of queues is allocated proportionally amongst the first set of queues based on the number of guaranteed PDUs and their respective sizes in each of the first set of queues.

13. The non-transitory computer-readable medium of claim 11, wherein the operations further comprise:
assigning a CoS to each of the PDUs to generate the set of CoS assignments for the PDUs.

14. The non-transitory computer-readable medium of claim 11, wherein the operations further comprise:
determining the available bandwidth in the second set of queues based on a number of the PDUs and their respective sizes that are stored in each of the second set of queues.

15. The non-transitory computer-readable medium of claim 11, wherein the operations further comprise:
assigning a Modcod scheme to each of the PDUs to generate the set of Modcod scheme assignments for the PDUs, wherein each of the set of Modcod scheme assignments includes one or both of a modulation scheme assignment or a coding rate assignment.

16. The non-transitory computer-readable medium of claim 15, wherein the set of Modcod scheme assignments are generated based on an estimated signal-to-noise ratio of a communication channel between the gateway and one or more terminals.

17. The non-transitory computer-readable medium of claim 11, wherein the operations further comprise:
after releasing the PDUs from the second set of queues, encapsulating the PDUs to produce baseband frames.

18. The non-transitory computer-readable medium of claim 17, wherein the operations further comprise:
modulating the baseband frames to produce digital waveforms;
digitizing the digital waveforms to produce analog signals; and
transmitting the analog signals to one or more terminals via a satellite.

19. A system comprising:
one or more processors; and
a non-transitory computer-readable medium comprising instructions that, when executed by the one or more processors, cause the one or more processors to perform operations for managing queues for transmission of protocol data units (PDUs) in a satellite communication system, the operations comprising:
receiving the PDUs at a gateway, the gateway having a first set of queues each corresponding to a different class of service (CoS) and a second set of queues each corresponding to a different modulation and coding (Modcod) scheme;
loading the PDUs into the first set of queues in accordance with a set of CoS assignments for the PDUs;
allocating an available bandwidth in the second set of queues amongst the first set of queues;
releasing the PDUs from the first set of queues in accordance with the allocated available bandwidth;
loading the PDUs into the second set of queues in accordance with a set of Modcod scheme assignments for the PDUs; and
releasing the PDUs from the second set of queues for transmission in the satellite communication system.

20. The system of claim 19, wherein allocating the available bandwidth in the second set of queues amongst the first set of queues includes counting a number of guaranteed PDUs that are stored in each of the first set of queues, wherein the available bandwidth in the second set of queues is allocated proportionally amongst the first set of queues based on the number of guaranteed PDUs and their respective sizes in each of the first set of queues.
